(19) United States
(12) Patent Application Publication
(10) Pub. No.: US 2009/0290607 A1
(43) Pub. Date: Nov. 26, 2009

(54) SIGNAL PROCESSING DEVICE FOR CONTROLLING LASER OUTPUT AND DEVICE FOR OBSERVING LASER ACTION PROCESS

(75) Inventor: Zhiyuan LIANG, Beijing (CN)

Correspondence Address: NovaTech IP Law, 1001 Avenue Pico, Suite C500, San Clemente, CA, 92673, US

(73) Assignee: Beijing Institute of Opto-Electronic Technology, Beijing (CN)

(21) Appl. No.: 12/351,791

(22) Filed: Jan. 9, 2009

(30) Foreign Application Priority Data
May 23, 2008 (CN) 200810112422.2

(51) Int. Cl. H01S 3/13

(52) U.S. Cl. 372/29.01

(57) ABSTRACT

The present invention relates to a signal processing device for controlling laser output and a device for observing laser action process. The device for observation includes a video camera for image acquisition and a monitor connected with the video camera, and it further includes a signal processing device for controlling laser output. A pulse signal of an electronic shutter of the video camera, after being processed by the signal processing device, is outputted to a controlling input port of a laser device. The signal processing device includes a control signal generating unit for generating a control signal according to the pulse signal of the electronic shutter by the image acquisition; a compression signal generating unit for compressing the pulse width of the generated envelope signal which is a signal for controlling the laser output according to the influence time on the image acquisition from the optical noise due to interaction between the laser and the material. The devices provided by the present invention can eliminate the high-brightness optical noise generated from the action between the laser and the material, and consequently the laser action process can be observed clearly.

### CROSS-REFERENCE TO RELATED APPLICATIONS

This application claims priority of China Patent Application No. 200810112422.2, filed on May 23, 2008, entitled “Signal Processing Device for Controlling Laser Output and Device for Observing Laser Action Process”, which is incorporated herein by reference in its entirety.

### FIELD OF THE TECHNOLOGY

The present invention relates to a signal processing device for controlling laser output and a device for observing laser action process, and particularly to a device for eliminating the high-brightness optical noise generated from the action between the laser and the material when the process of the action between the laser and the material is observed through a TV monitoring system.

### BACKGROUND OF THE INVENTION

The laser is a Light Amplification by Stimulated Emission of Radiation and has characteristics such as high brightness, good directivity, monochromaticity and so on. Besides it is easy to focus the laser to one point and obtain extremely high power density or energy density at the focus. When the laser acts on a metal material, the laser can melt and even evaporate the metal material; when the laser acts on a nonmetal material, the laser can carbonize, burn and even evaporate the material; when the laser acts on an animal tissue, the laser can coagulation, carbonize and even evaporate the tissue. Therefore the laser is widely used in material processing to perform perforation, incision, welding and heat treatment etc. on the object to be processed. And also it is widely used in the medical treatment to coagulation, carbonize or evaporate the tissue, which can melt or incise the tissue and that to achieve the goal of treatment. The laser with a certain wavelength also can be transmitted by an optical fiber to be lead into the intra-cavity of the object for processing it.

However, two problems appear in the process of monitoring the action between the laser and the material. One is that the laser is a very high power laser, and if it is also a laser in the visible band, eyes illuminated by the scattered light of the high power laser can not see other objects clearly. This problem can be resolved simply. Because each laser has a single wavelength, it can be filtered by eyeglasses, meanwhile laser protection also demands wearing the protective glasses for filtering the laser with the wavelength. The other problem is that the temperature of part of the material may rise rapidly, and then the material burns and emits strong lights when the high power laser acts reciprocally with the material. Especially, when the laser is a pulsed laser, even a blast and very strong spark may be generated at the focus, which may also make eyes unable to see the circumstances of the action point and the action process clearly. The spectral line of the strong light generated from the burning and the blast is very wide. Wearing a pair of black eyeglasses with high density is needed if we want to filter them. Then any of other things may be invisible when the strong lights are filtered. As the above laser action processes are all observed by eyes, the same problem may appear while observing through a video camera. The laser with a single wavelength is easy to be filtered, however the strong light with wide spectral line generated from the interaction between the laser and the material is hard to filter. Therefore, the high-brightness optical noise in the laser action process still can not be filtered in the prior art.

### SUMMARY OF THE INVENTION

The object of the present invention is to provide a signal processing device for controlling laser output and a device for observing a laser action process for overcoming the deficiencies in prior art that high brightness optical noise generated from the laser action process can not be eliminated in observing a interaction process between a laser and a material with a TV monitoring system, and consequently the action process between the laser and the material can be observed clearly.

In order to implement the above object, the present invention provides a signal processing device for controlling laser output. It concretely includes:
a control signal generating unit for generating a control signal according to a pulse signal of an electronic shutter for image acquisition; and
a compression signal generating unit for compressing pulse width of a generated envelope signal according to influence time on the image acquisition from an optical noise of interaction between a laser and a material, wherein said envelope signal is a signal for controlling laser output.

The present invention further provides a device for observing laser action process, including a video camera for image acquisition and a monitor connected to said video camera. The device further includes a signal processing device for controlling laser output. A pulse signal of an electronic shutter of said video camera is outputted to a controlling input port of a laser device after being processed by said signal processing device and said signal processing device includes:
a control signal generating unit for generating a control signal according to a pulse signal of an electronic shutter for image acquisition; and
a compression signal generating unit for compressing pulse width of a generated envelope signal according to influence time on the image acquisition from an optical noise of interaction between a laser and a material, wherein said envelope signal is a signal for controlling laser output.

Said video camera is provided with an electronic shutter and the working principle of it is as follows. The action time on the video camera CCD chip of the incident light is controlled through controlling the charge accumulating time of each pixel in order to implement the electronic shutter, that is, only the charges generated in a certain period of time is used as the image signal outputted in each field of the TV screen display and the charges generated in other periods of time will be released and will not be used. In this way, the time of charge storing is reduced, namely the time of light irradiating the chip is reduced, just like a shutter is added.

When the video camera is working, a pulse signal of the electronic shutter is generated and charges are accumulated on the CCD chip. The relationship between the two and the screen display time of said TV monitor is shown by (8-a) in the FIG. 8 and (8-b) in the FIG. 8 respectively. FIG. 8 is a schematic view of the temporal variation of each parameter. (8-a) in the FIG. 8 is a schematic view of the relationship between the pulse signal of the electronic shutter in the video camera and the screen display time of the TV monitor. (8-b) in the FIG. 8 is a schematic view of the relationship between the accumulation amount of charges on the video camera CCD chip and the screen display time of the TV monitor. The screen display time of said TV monitor is 1/50s per field, which is divided into two parts: an output time of the shutter pulse t1 and a stopping time of the shutter pulse t2, corresponding to the closing time and the opening time of the shutter respectively. Within the time of shutter pulse output t1, the charges accumulated on said video camera CCD chip is released; while within the time of shutter pulse stopping, that is, the time of shutter opening, t2, the light is integrated by the CCD chip and the interaction between the laser and the material is recorded by the CCD and conversed to be the image displayed on the screen. The speed of the electronic shutter can change from 1/50s to 1/100000s. If the laser is outputted within the time of electronic shutter closing, the laser and the strong light generated from the interaction between the laser and the material may not appear on the TV monitoring screen.

Therefore, the present invention can eliminate interference due to the laser and the high brightness optical noise generated from the interaction between the laser and the material during observing the interaction process between the laser and the material by using a video camera and a TV monitor in various occasions of the interaction between the laser and the material such as laser material processing, laser medical treatment and so on, so as to observe the laser action process clearly.

The present invention will be described in more detail with reference to the views and embodiments.

### BRIEF DESCRIPTION OF THE DRAWINGS

FIG. 1 is a structure view of the embodiment 1 of a signal processing device for controlling the laser output according to the present invention;

FIG. 2 is a structure view of the embodiment 2 of a signal processing device for controlling the laser output according to the present invention;

FIG. 3 is a structure view of the embodiment 3 of a signal processing device for controlling the laser output according to the present invention;

FIG. 4 is a structure view of the embodiment 4 of a signal processing device for controlling the laser output according to the present invention;

FIG. 5 is a structure view of the embodiment 1 of the device for observing the laser action process according to the present invention;

FIG. 6 is a structure view of the embodiment 4 of the device for observing the laser action process according to the present invention;

FIG. 7 is a structure view of the embodiment 5 of the device for observing the laser action process according to the present invention;

FIG. 8 is a schematic view of the temporal variation of each parameter according to the present invention;

FIG. 9 is another schematic view of temporal variation of each parameter according to the present invention.

### VIEWS SIGNS

| | | |
|---|---|---|
| 1-CCDvideo camera | 2-signal processing device | 21-control signal |
| | | generating unit |
| 22-compression signal | 211-current driver | 212-reference |
| generating unit | | voltage generator |
| 213-amplitude | 214-inverter | 215-integrator |
| comparator | | |
| 21-counter | 222-compressing calculator | 223-Single chip |
| | | microprocessor |
| 3-laser output controller | 4-laser | 5-TV monitor |
| 6-video signal brightness | 7-illuminating light source | |
| compensator | | |

### DETAILED DESCRIPTION OF THE PREFERRED EMBODIMENTS

FIG. 1 is a structure view of the embodiment 1 of a signal processing device for controlling the laser output according to the present invention. The signal processing device 2 includes a control signal generating unit 21 for generating a control signal according to the pulse signal of the electronic shutter by image acquisition and a compression signal generating unit 22 for compressing the pulse width of the generated envelope signal according to the influence time on the image acquisition from the optical noise of the interaction between the laser and the material. Said envelope signal is a signal for controlling the laser output. The input of the control signal generating unit 21 is a pulse signal of the electronic shutter. After being processed, the control signal is outputted. The control signal can be a pulse signal or an envelope signal having the same frequency with the pulse signal of the electronic shutter or other signals having the same frequency with the pulse signal of the electronic shutter. The control signal is inputted to the compression signal generating unit 22 and is compressed according to the influence time on the image acquisition from the optical noise of the interaction between the laser and the material to generate the envelope signal for controlling the laser output. Because the compressing is made according to the influence time on the image acquisition from the optical noise of the interaction between the laser and the material, the outputted envelope signal for controlling the laser output can eliminate the interference of the high-brightness optical noise generated from the laser or from the action between the laser and the material.

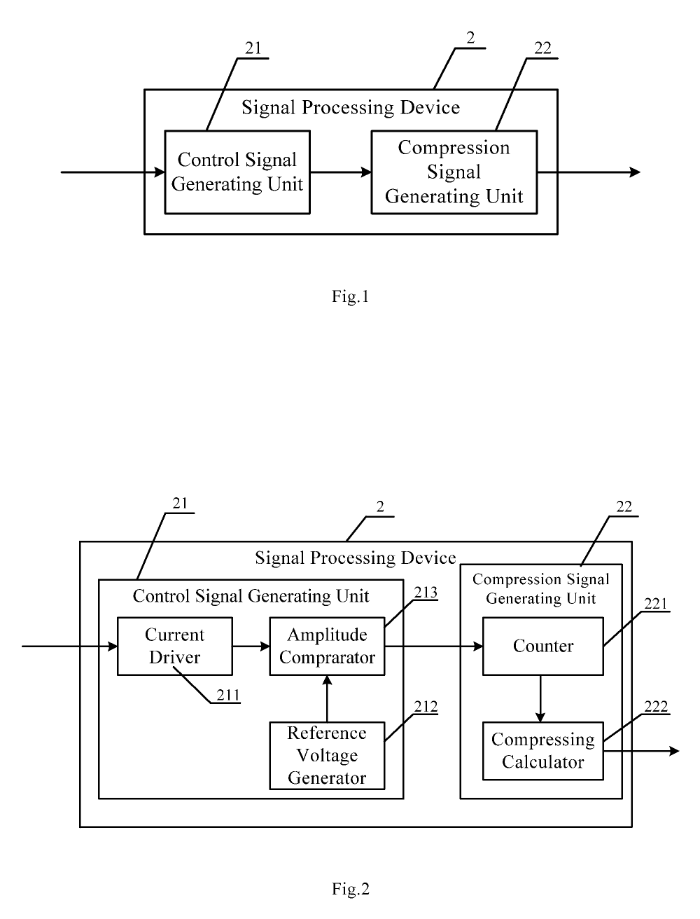

FIG. 2 is a structure view of the embodiment 2 of a signal processing device for controlling the laser output according to the present invention. The signal processing device 2 includes a control signal generating unit 21 and a compression signal generating unit 22. The control signal generating unit 21 includes a current driver 211 for performing current amplification on the pulse signal of the electronic shutter, a reference voltage generator 212 for outputting a reference voltage and an amplitude comparator 213 for outputting the control signal after comparing the pulse signal of the electronic shutter after being performed the current amplification with the reference voltage. The input of the amplitude comparator 213 is connected to the current driver 211 and the reference voltage generator 212 and the outputted control signal is a pulse signal. The compression signal generating unit 22 includes a counter 221 for counting the pulse number of the pulse signal and a compressing calculator 222 for performing compression calculation on the pulse signal according to the influence time on the image acquisition from the optical noise of the interaction between the laser and the material. The input of the compressing calculator 222 is connected to the counter 221 and the output is the envelope signal for controlling the laser output.

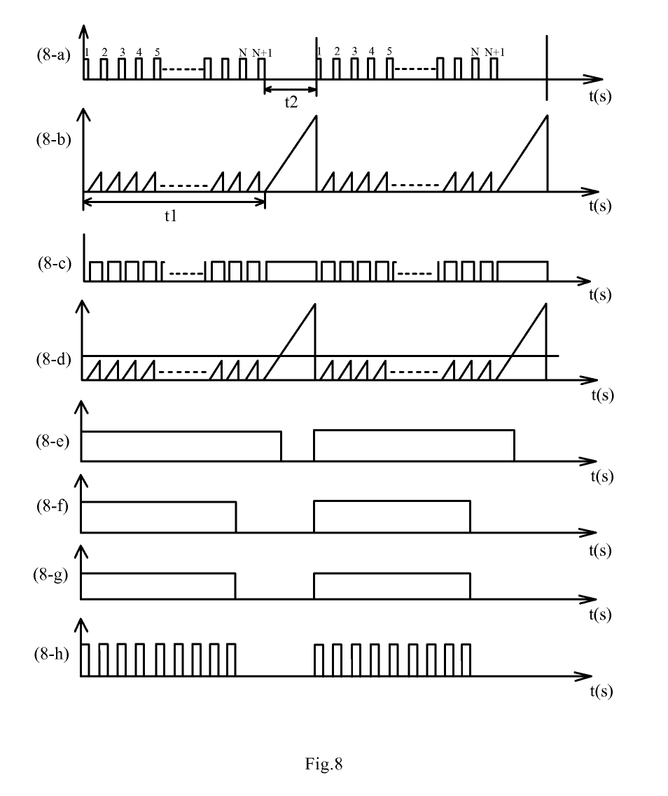

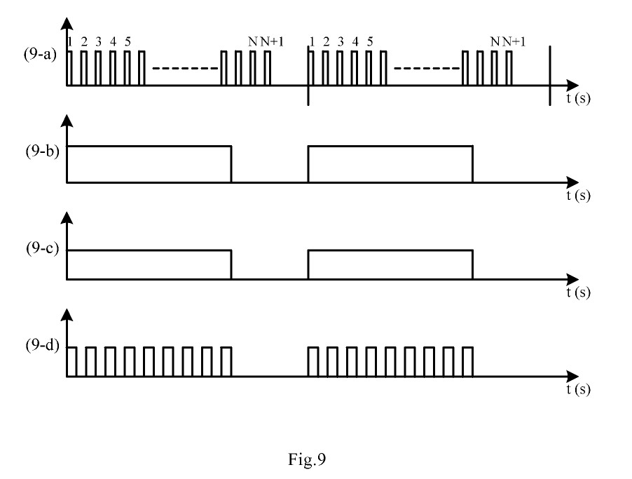

The pulse signal of the electronic shutter is as shown by (8-a) in the FIG. 8. Because the current of the pulse signal of the electronic shutter is weak, the pulse signal of the electronic shutter is amplified by the current driver, and then is inputted into the amplitude comparator 213 to be compared with the reference voltage inputted from the reference voltage generator 212 and a pulse signal of which the frequency is exactly the same as the frequency shown by (8-a) except for a different amplitude value, as shown in (9-a) in the FIG. 9, is outputted after shaping. In the current field, the pulse signal is counted by the counter 221 to define the pulse number of the pulse signal of the electronic shutter in each field which is from 1 to N+1. The frequency of the pulse signal of the electronic shutter is f and the compressed pulse number n=t′f is calculated by the compressing calculator 222 according to the influence time t′, on the image acquisition from the optical noise of the interaction between the laser and the material. The pulse number N′ after being compressed can be obtained by subtracting the pulse number corresponding to the compressing time from the pulse number of the electronic shutter in each field, the formula of which is as follows.

N′=(N+1)−n

The time value t=N′/f which is calculated from the value of N′ of the current field is used to be the laser permitting output time in the next field, and the rest may be deduced by analogy. In the first field, the laser does not work and the compressing calculator 222 remains the value of N′. In every follow-up field, the value of N′ obtained by calculating in the previous field is used. The compressing calculator 222 sets the electrical level of the outputted envelope signal, i.e. the envelope electrical level after being compressed as high at the same time when detecting the rising edge of the first pulse signal opened by the electronic shutter is detected. The compressing calculator 222 sets the output signal as low when detecting that the number of the pulse signals is N′ so as to obtain the envelope signal after the pulse width is compressed, as shown in (9-b) in the FIG. 9. The envelope signal insures that the optical noise generated at the process of the interaction between the laser and the material can end before the electronic shutter opens. If the laser 4 formerly outputs a continuous laser, the controlled laser output after the pulse width is compressed by the compressing calculator 222 will become to be the waveform as shown in (9-c) in the FIG. 9, of which the ordinate represents the output power. If the laser 4 formerly outputs a pulse laser, the controlled laser output after the pulse width is compressed by the compressing calculator 222 will become to be the waveform as shown in (9-d) in the FIG. 9, of which the ordinate is the output energy value and of which the inherent repetition frequency of the laser pulse keeps the same except that the pulse laser output ends before the electronic shutter opens.

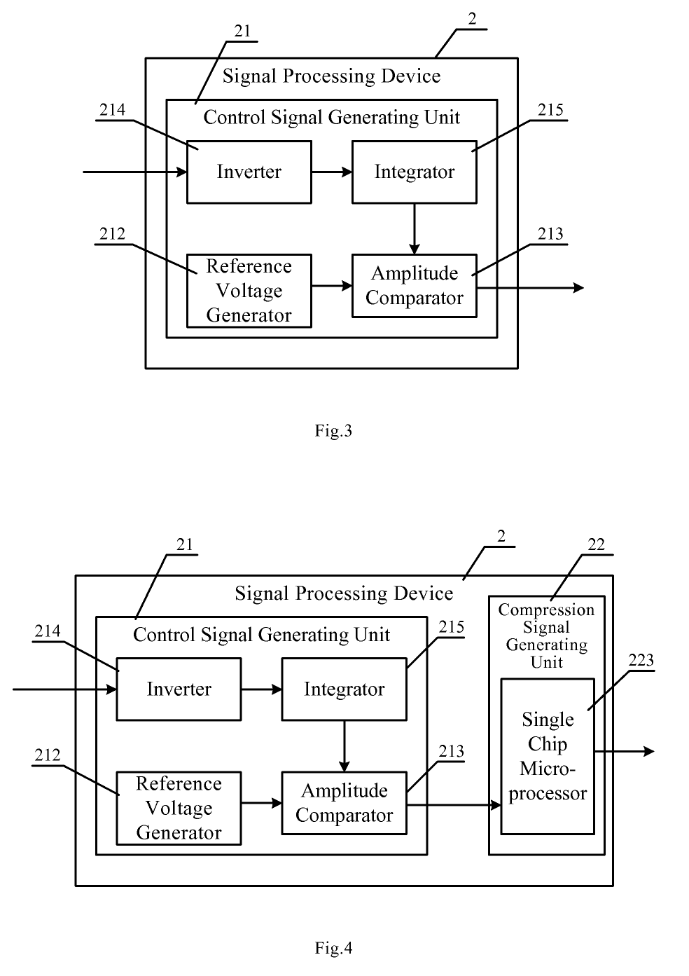

FIG. 3 is a structure view of the embodiment 3 of a signal processing device for controlling the laser output according to the present invention. The signal processing device 2 includes a control signal generating unit 21 and a compression signal generating unit 22. The control signal generating unit 21 includes an inverter 214 for reversing the phase of the pulse signal of the electronic shutter, an integrator 215 for integrating the signal with reversed phase, the input of which is connected to the inverter 214, a reference voltage generator 212 for outputting a reference voltage and an amplitude comparator 213 for outputting a control signal after comparing the signal outputted form the integrator 215 with the reference voltage. The input of the amplitude comparator 213 is connected to the integrator 215 and the reference voltage generator 212 and the control signal is an envelope pulse signal.

The phase of the pulse signal of the electronic shutter is reversed by the inverter 214 and the waveform of the pulse signal of the electronic shutter after the reverse is shown by (8-c) in the FIG. 8. FIG. 8 is a view of the temporal variation of each parameter in the present invention. (8-c) in the FIG. 8 is a schematic view of the relationship between the reversed pulse signal of the electronic shutter from the signal processing device for eliminating the laser action process and the screen display time of the TV monitor, of which the abscissa represents the time and the ordinate represents the reversed pulse signal of the electronic shutter. The reversed pulse signal of the electronic shutter integrates the reversed shutter pulse voltage through the integrator 215. The integrator 215 is provided with the function of resetting the output voltage by the fall edge of the pulse. The voltage waveform outputted from the integrator 215 is as shown by (8-d) in the FIG. 8. It is a schematic view of the relationship between the integrating voltage of the reversed pulse signal of the electronic shutter from the signal processing device for eliminating the laser action process and the screen display time of the TV monitor, of which the ordinate represents the voltage value. The reference voltage generator 212 generates the reference voltage and sets the reference voltage a little greater than the maximum value of the voltage outputted by the integrator within the shutter closing time. The output voltage of the integrator 215 is compared with the reference voltage by the amplitude comparator. When the output voltage of the integrator 215 is greater than the reference voltage, the amplitude comparator 213 outputs a low level, and when it is less than the reference voltage, the amplitude comparator 213 outputs a high level. The output of the amplitude comparator 213 forms a schematic view of the relationship between the envelope signal outputted from the signal processing device for eliminating the laser action process and the screen display time of the TV monitor, of which the ordinate represents the voltage value, that is, the envelope signal for controlling the laser emission and the envelope signal is sent to the laser output controller 3 as shown (8-e) in the FIG. 8.

FIG. 4 is a structure view of the embodiment 4 of a signal processing device for controlling the laser output according to the present invention. The difference between the present embodiment and the signal processing device for controlling the laser output in the embodiment 3 lies in that a single chip microprocessor 223 is added on the basis of the signal processing device for controlling the laser output in the embodiment 3. The compression signal generating unit 22 concretely includes the single chip microprocessor 223 for performing the compression calculation on the envelope pulse signal according to the influence time on the image acquisition from the optical noise of the interaction between the laser and the material to adjust the pulse width of the envelope pulse signal. The input of the single chip microprocessor 223 is connected to the output of the amplitude comparator 213 and the pulse signal of the electronic shutter. As shown in the FIG. 4, the envelope pulse signal and the pulse signal of the electronic shutter are processed by the single chip microprocessor 223. In the first field, the counter of the single chip microprocessor 223 counts the pulse signal of the electronic shutter to define the pulse number of the electronic shutter pulse in each field which is from 1 to N+1. The frequency of the electronic shutter pulse is f and the compressing time t′ is determined according to the influence time on the image acquisition from the optical noise of the interaction between the laser and the material. The pulse number N′ after being compressed can be obtained by subtracting the pulse number corresponding to the compressing time from the pulse number of the electronic shutter in each field, the formula of which is as follows.

N′=(N+1)−t′f

When t′f is decimal fraction, the value of t′f equals to the integral part of it with 1 added. In the first field, only the value of N′ is calculated, the laser does not work and the single chip microprocessor 223 remains the value of N′. In every follow-up field, the single chip microprocessor 223 sets the output electrical level, i.e. the electrical level of the envelope signal after being compressed as high at the same time when detecting the rising edge of the envelope signal in the current field. The single chip microprocessor 223 sets the output signal as low when detecting that the number of the shutter pulse is N′ (the pulse number after being compressed obtained by calculation in the previous field) so as to obtain the envelope signal after the pulse width is compressed. The envelope signal after being compressed insures that the optical noise generated from the process of the interaction between the laser and the material ends before the electronic shutter opens. If the laser 4 formerly outputs a continuous laser, the controlled laser output after the pulse width is compressed by the single chip microprocessor 223 will become to be the waveform as shown by (8-g) in the FIG. 8, of which the ordinate represents the output power. If the laser 4 formerly outputs a pulse laser, the controlled laser output after the pulse width is compressed by the single chip microprocessor 223 will become to be the waveform as shown by (8-h) in the FIG. 8, of which the ordinate is the output energy value and of which the inherent repetition frequency of the laser pulse keeps the same except that the output of the pulse laser ends before the electronic shutter opens.

FIG. 5 is a structure view of the embodiment 1 of the device for observing the laser action process according to the present invention. It includes a video camera 1 for image acquisition and a monitor 5 connected with said video camera, and also includes a signal processing device 2 for controlling the laser output. The pulse signal of the electronic shutter of the video camera 1 is outputted to a controlling input port of a laser device after being processed by the signal processing device 2.

In the signal processing device 2, the control signal can be generated according to the pulse signal of the electronic shutter of image acquisition and the pulse width of the generated envelope signal can be compressed according to the influence time on the image acquisition from the optical noise of the interaction between the laser and the material. Said envelope signal is a signal for controlling the laser output, that is, the inputted pulse signal of the electronic shutter. After being processed, the control signal is outputted. The control signal can be a pulse signal or an envelope signal having the same frequency with the pulse signal of the electronic shutter or other signals having the same frequency with the pulse signal of the electronic shutter. The control signal is inputted to the compression signal generating unit and is compressed according to the influence time on the image acquisition from the optical noise of the interaction between the laser and the material to generate the envelope signal for controlling the laser output.

The outputted envelope signal, that is, the control signal for controlling the laser emission is sent to the laser output controller 3. The laser output controller 3 controls the output of the laser 4 according to the control signal. The laser output controller 3 and the laser 4 are collectively called laser devices. The laser 4 is opened to output the laser when the electronic shutter is closed; the laser 4 is closed to stop outputting the laser when the electronic shutter is opened, so as to realize observing the laser action process by elimination.

The structure of the device for observing the laser action process in the embodiment 2 of the present invention is shown as the FIG. 5. The internal structure of the signal processing device 2 is shown as the FIG. 2. The CCD video camera 1 photographs the interaction process between the laser and the material and sends the photographed pictures to the TV monitor 5. The signal processing device 2 connected to the video camera 1 extracts the pulse signal of the electronic shutter from the video camera 1 and processes it.

The pulse signal of the electronic shutter is as shown by (8-a) in the FIG. 8. Because the current of the pulse signal of the electronic shutter is weak, the pulse signal of the electronic shutter is amplified by a current driver, and then is inputted into an amplitude comparator to be compared with the reference voltage inputted from the reference voltage generator after shaping. And then a pulse signal of which the frequency is exactly the same as the frequency shown by (8-a) except for a different amplitude value is outputted, as shown in (9-a) in the FIG. 9. In the current field, the pulse signal is counted by the counter to define the pulse number of the pulse signal of the electronic shutter in each field which is from 1 to N+1. The frequency of the pulse signal of the electronic shutter is f and the compressed pulse number n=t′f is calculated by the compressing calculator according to the influence time t′ on the image acquisition from the optical noise of the interaction between the laser and the material. The pulse number N′ after being compressed can be obtained by subtracting the pulse number corresponding to the compressing time from the pulse number of the electronic shutter in each field, the formula of which is as follows.

N′=(N+1)−n

The time value t=N′/f which is calculated from the value of N′ of the current field is used to be the laser permitting output time in the next field, and the rest may be deduced by analogy. In the first field, the laser does not work and the compressing calculator remains the value of N′. In every follow-up field, the value of N′ obtained by calculating in the previous field is used. The compressing calculator sets the electrical level of the outputted envelope signal, i.e. the envelope level after being compressed as high at the same time when detecting the rising edge of the first pulse signal opened by the electronic shutter. The compressing calculator sets the output signal as low when detecting that the number of the pulse signals equals to N′, so as to obtain the envelope signal after the pulse width is compressed, as shown in (9-b) in the FIG. 9.

The outputted envelope signal, that is, the control signal for controlling the laser emission is sent to the laser output controller 3. The laser output controller 3 controls the output of the laser 4 according to the control signal. The laser 4 is opened to output the laser when the electronic shutter is closed; the laser 4 is closed to stop outputting the laser when the electronic shutter is opened, so as to realize observing the laser action process by elimination.

The structure of the device for observing the laser action process in the embodiment 3 of the present invention is shown as the FIG. 5. The internal structure of the signal processing device 2 is shown as the FIG. 3. The CCD video camera 1 photographs the interaction process between the laser and the material and sends the photographed picture to the TV monitor 5. The signal processing device 2 connected to the video camera 1 extracts the pulse signal of the electronic shutter from the video camera 1 and processes it. The phase of the pulse signal of the electronic shutter is reversed by the inverter and the waveform of the reversed pulse signal of the electronic shutter is shown by (8-c) in the FIG. 8. The reversed pulse signal of the electronic shutter integrates the reversed shutter pulse voltage through the integrator. The integrator is provided with the function of resetting the output voltage by the fall edge of the pulse and the voltage waveform outputted from the integrator is as shown by (8-d) in the FIG. 8. The reference voltage generator generates a reference voltage and set the reference voltage a little greater than the maximum value of the output voltage of the integrator within the shutter closing time. The output voltage of the integrator is compared with the reference voltage by the amplitude comparator. When the output voltage of the integrator is greater than the reference voltage, the amplitude comparator outputs a low level; when it is less than the reference voltage, the amplitude comparator outputs a high level. The output of the amplitude comparator forms the envelope signal, that is, the control signal for controlling the laser emission as shown by (8-e) in the FIG. 8, and the control signal is sent to the laser output controller 3.

The laser output controller 3 controls the output of the laser 4 according to the control signal. The laser 4 is opened to output the laser when the electronic shutter is closed; the laser 4 is closed to stop outputting the laser when the electronic shutter is opened, so as to realize observing the laser action process by elimination.

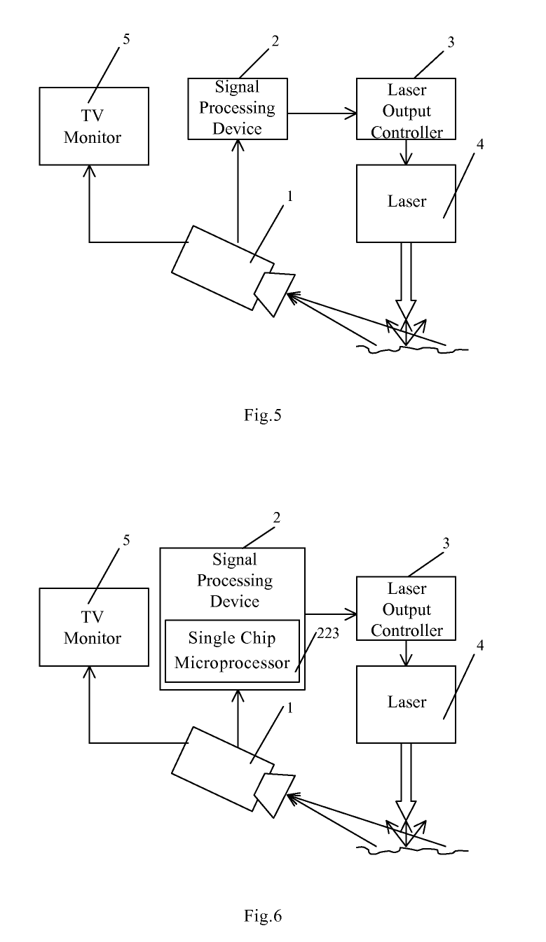

FIG. 6 is a structure view of the embodiment 4 of the device for observing the laser action process according to the present invention. Because the burning or the spark of the explosion generated from the interaction process between the laser and the material always occurs after the laser output acts on the material, that is, lagging behind the laser and having a certain luminescence lifetime. The embodiment 3 of the device for observing the laser action process can completely eliminate the influence of the optical noise of the laser and can also eliminate a great deal of the spark noise generated along with the laser output, but can not eliminate the optical noise generated from the interaction between the laser and the material of the laser output port when the electronic shutter is about to open. Therefore, the spark may form the optical noise on the display screen during the opening time of the electronic shutter. In order to resolve this problem, it is needed to stop the laser output in advance according to the luminescence lifetime of the spark.

The concrete implementation method is shown in the FIG. 6. The signal processing device 2 is further provided with a single chip microprocessor 223 whose function is to compress the width of the envelope pulse signal outputted by the signal processing device 2 according to the length of the luminescence lifetime of the spark. The envelope signal after the pulse width is compressed becomes the control signal for practically controlling the laser output as shown by (8-f) in the FIG. 8. The envelope pulse signal and the pulse signal of the electronic shutter are processed by the single chip microprocessor 223. In the first field, the counter of the single chip microprocessor counts the pulse signal of the electronic shutter to define the pulse number of the electronic shutter pulse in each field which is from 1 to N+1. The frequency of the electronic shutter pulse is f and the compressing time t′ is determined according to the influence time on the image acquisition from the optical noise of the interaction between the laser and the material. The pulse number N′ after being compressed can be obtained by subtracting the pulse number corresponding to the compressing time from the pulse number of the electronic shutter in each field, the formula of which is as follows.

N′=(N+1)−t′f

When t′f is decimal fraction, the value of t′f equals to the integral part with 1 added. In the first field, only the value of N′ is calculated, the laser does not work and the single chip microprocessor remains the value of N′. In every follow-up field, the single chip microprocessor sets the output electrical level, i.e. the electrical level of the envelope signal after being compressed as high at the same time when detecting the rising edge of the envelope signal. The single chip microprocessor sets the output signal as low when detecting the number of the shutter pulses equals to N′ (the pulse number after compressing obtained by calculation in the previous field), so as to obtain the envelope signal after the pulse width is compressed. The control signal insures that the optical noise generated from the process of the interaction between the laser and the material ends before the electronic shutter opens. If the laser 4 formerly outputs a continuous laser, the controlled laser output after the pulse width is compressed by the single chip microprocessor 223 will become to be the waveform as shown by (8-g) in the FIG. 8. If the laser 4 formerly outputs a pulse laser, the controlled laser output after the pulse width is compressed by the single chip microprocessor 223 will become to be the waveform as shown by (8-h) in the FIG. 8, of which the inherent repetition frequency of the laser pulse keeps the same except that the pulse laser output ends before the electronic shutter opens. Other action processes are the same the embodiment 3 of the device for observing the laser action process so unnecessary details will not be described here.

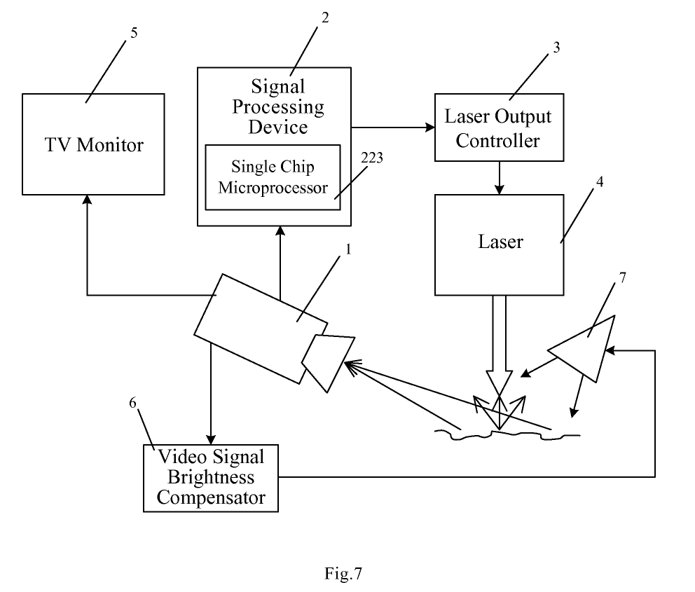

FIG. 7 is a structure view of the embodiment 5 of the device for observing the laser action process according to the present invention. In the above embodiments, two problems appear as a result of using the electronic shutter. One is that the pause time of the laser is increased after the controlling for the laser output by the envelope signal is added, namely the average power or energy of the laser output is reduced. If the opening time of the electronic shutter t2 is 1/50s, namely the electronic shutter is opened at all the time in each field but no laser is outputted. If the opening time of the electronic shutter t2 is 1/100s, namely the electronic shutter is opened at half time of the 1/50s in each field, the average power or energy of the laser output after being controlled by the envelope signal will be reduced by a half. If the opening time of the electronic shutter t2 is 1/1000s, namely the electronic shutter is opened at 5% time of the 1/50s in each field, the average power or energy of the laser output after being controlled by the envelope signal will only be reduced by 5%. Therefore, in order to reduce the influence of the average power or energy of the laser output, the electronic shutter with higher speed is needed to be selected. For example, the opening time of the electronic shutter is set as 1/1000s. However, the other problem appears thereupon, that is, the shorter the opening time of the electronic shutter is, the shorter the time of exposure on the laser acting position is, so that the interaction process between the laser and the material may not be seen clearly. In order to resolve this problem, the illumination on the laser acting position is needed to be increased, that is, compensative illumination is provided for the laser acting position.

The concrete implementation method is shown in the FIG. 7. The video camera 1 is externally connected to a video signal brightness compensator 6 and the video signal brightness compensator 6 is further connected to an illuminating light source 7. Said video signal brightness compensator 6 extracts and monitors the brightness of the video signal from the video camera, and sends out a compensation signal to the illuminating light source 7 along with the fluctuation of the brightness of the video signal to control the illuminating light source to decrease or increase the illumination so as to satisfy the material field lighting needed because of the speed change of the electronic shutter automatically. When an endoscope is used for a laser surgery in the body cavity, the illuminating light source 7 is a cold light source. Certainly, if the speed of the electronic shutter does not often change after being selected, the automatic compensative controlling on the illuminating light source 7 by the video signal brightness compensator 6 may not be adopted; instead a manual method may be used to adjust the material field illumination to the extent that the image with suitable brightness on the TV monitoring screen is obtained. Other action processes are the same as the embodiment 4 of the device for observing the laser action process so unnecessary details will not be described here.

Finally, it should be understood that the above embodiments are only used to explain, but not to limit the technical solution of the present invention. In despite of the detailed description of the present invention with referring to above preferred embodiments, it should be understood that various modifications, changes or equivalent replacements can be made by those skilled in the art without departing from the spirit and scope of the present invention and covered in the claims of the present invention.

What is claimed is:

1. A signal processing device for controlling laser output, comprising:
a control signal generating unit for generating a control signal according to a pulse signal of an electronic shutter for image acquisition; and
a compression signal generating unit for compressing pulse width of a generated envelope signal according to influence time on the image acquisition from an optical noise of interaction between a laser and a material, wherein said envelope signal is a signal for controlling laser output.

2. The device according to claim 1, wherein said control signal generating unit comprises:
a current driver for performing current amplification on said pulse signal of the electronic shutter;
a reference voltage generator for outputting a reference voltage; and
an amplitude comparator for outputting said control signal after comparing said pulse signal of the electronic shutter on which the current amplification is performed with the reference voltage, wherein an input of said amplitude comparator is connected to said current driver and said reference voltage generator, and said control signal is a pulse signal.

3. The device according to claim 1, wherein said compression signal generating unit comprises:
a counter for counting the pulse number of said pulse signal; and
a compressing calculator for performing compression calculation on the pulse signal according to the influence time on the image acquisition from the optical noise of the interaction between the laser and the material, wherein an input of said compressing calculator is connected to the counter and an output is an envelope signal for controlling the laser output.

4. The device according to claim 1, wherein said control signal generating unit comprises:
an inverter for reversing the phase of said pulse signal of the electronic shutter;
an integrator for integrating the signal after reversing the phase, wherein an input of said integrator is connected to said inverter;
a reference voltage generator for outputting an reference voltage; and
an amplitude comparator for outputting said control signal after comparing the signal outputted from said integrator with said reference voltage, wherein an input of said amplitude comparator is connected to said integrator and said reference voltage generator, and said control signal is an envelope pulse signal.

5. The device according to claim 4, wherein said compression signal generating unit concretely is a single chip microprocessor for performing compression calculation on the envelope pulse signal and adjusting the pulse width of the envelope pulse signal according to the influence time on the image acquisition from the optical noise of the interaction between the laser and the material; an input of said single chip microprocessor is connected to an output of said amplitude comparator and the pulse signal of the electronic shutter.

6. A device for observing laser action process, comprising a video camera for image acquisition and a monitor connected to said video camera, further comprising a signal processing device for controlling laser output, wherein a pulse signal of an electronic shutter of said video camera is outputted to a controlling input port of a laser device after the pulse signal is processed by said signal processing device and said signal processing device comprises:
a control signal generating unit for generating a control signal according to a pulse signal of an electronic shutter for image acquisition; and
a compression signal generating unit for compressing pulse width of a generated envelope signal according to influence time on the image acquisition from an optical noise of interaction between a laser and a material, wherein said envelope signal is a signal for controlling laser output.

7. The device according to claim 6, wherein said control signal generating unit comprises:
a current driver for performing current amplification on said pulse signal of the electronic shutter;
a reference voltage generator for outputting a reference voltage; and
an amplitude comparator for outputting said control signal after comparing said pulse signal of the electronic shutter on which the current amplification is performed with the reference voltage, wherein an input of said amplitude comparator is connected to said current driver and said reference voltage generator, and said control signal is a pulse signal.

8. The device according to claim 7, wherein said compression signal generating unit comprises:
a counter for counting the pulse number of said pulse signal; and
a compressing calculator for performing compression calculation on the pulse signal according to the influence time on the image acquisition from the optical noise of the interaction between the laser and the material, wherein an input of said compressing calculator is connected to the counter and an output is an envelope signal for controlling the laser output.

9. The device according to claim 6, wherein said control signal generating unit comprises:
an inverter for reversing the phase of said pulse signal of the electronic shutter;
an integrator for integrating the signal after reversing the phase, wherein an input of said integrator is connected to said inverter;
a reference voltage generator for outputting an reference voltage; and
an amplitude comparator for outputting said control signal after comparing the signal outputted from said integrator with said reference voltage, wherein an input of said amplitude comparator is connected to said integrator and said reference voltage generator, and said control signal is an envelope pulse signal.

10. The device according to claim 9, wherein said compression signal generating unit concretely is a single chip microprocessor for performing compression calculation on the envelope pulse signal and adjusting the pulse width of the envelope pulse signal according to the influence time on the image acquisition from the optical noise of the interaction between the laser and the material; an input of said single chip microprocessor is connected to an output of said amplitude comparator and the pulse signal of the electronic shutter.

11. The device according to claim 6, wherein said video camera is further connected to a video signal brightness compensator and an output port of the video signal brightness compensator is connected to an illuminating light source for providing compensation illumination.

12. The device according to claim 11, wherein said illuminating light source is a common light source or a cold light source.

13. The device according to claim 6, wherein said laser device is formed by connecting a laser to a laser output controller, an input of said laser output controller is connected to an output of said signal processing device, and an output signal of said laser output controller is connected to said laser.

14. The device according to claim 13, wherein said laser is a continuous laser or a pulse laser used in industrial processing or medical equipment.
